(19) United States
(12) Patent Application Publication
(10) Pub. No.: US 2025/0013433 A1
(43) Pub. Date: Jan. 9, 2025

(54) METHOD AND DEVICE FOR GENERATING RANDOM PERMUTATIONS, AND PROCESSOR INCLUDING RANDOM PERMUTATION GENERATING LOGIC CIRCUIT

(71) Applicant: Samsung Electronics Co., Ltd., Suwon-si (KR)

(72) Inventor: Jongyeon PARK, Suwon-si (KR)

(73) Assignee: Samsung Electronics Co., Ltd., Suwon-si (KR)

(21) Appl. No.: 18/618,558

(22) Filed: Mar. 27, 2024

(30) Foreign Application Priority Data
Jul. 3, 2023 (KR) 10-2023-0086099
Aug. 28, 2023 (KR) 10-2023-0113070

(51) Int. Cl. G06F 7/58

(52) U.S. Cl. CPC G06F 7/588

(57) ABSTRACT

A processor includes a controller configured to respectively assign different index numbers to a plurality of operations, a shuffling logic configured to perform a bitwise operation based on a modular addition operation and a rotation shift operation on each of the index numbers and to shuffle the index numbers, and an operation logic configured to perform the plurality of operations based on the shuffled index numbers.

### CROSS-REFERENCE TO RELATED APPLICATION(S)

This U.S. non-provisional application claims priority under 35 USC § 119 to Korean Patent Application Nos. 10-2023-0086099, filed on Jul. 3, 2023 and 10-2023-0113070, field on Aug. 28, 2023, in the Korean Intellectual Property Office, the disclosure of each of which is herein incorporated by reference in their entirety.

### BACKGROUND

Various example embodiments relate to a method and a device for generating random permutations, and a processor including a random permutation generating logic circuit.

Many security technologies use random permutations.

In the field of post-quantum cryptography (PQC), e.g., of cryptography that is or is more likely to be secure even in the presence of quantum computers, there are methods such as lattice-based cryptography and/or code-based cryptography. Such methods include vector operations which enable or help to enable parallel processing. Parallel vector operations implement hiding countermeasures to defend or help defend against side-channel analysis (SCA) attacks. To use hiding countermeasures efficiently, there is a need or a desire for technology to generate random permutations in a manner that ensures or that helps to ensure security.

In the related arts, the Fisher-Yates shuffle has been used as a random permutation generation method of shuffling a plurality of elements included in a sequence. The Fisher-Yates shuffling has factorial complexity, e.g., has complexity that scales factorially. However, the Fisher-Yates shuffle requires a significantly large storage space and is unsuitable for parallel processing. For example, according to Fisher-Yates shuffle, the next round of shuffling is performed based on a result of a previous round of shuffling.

### SUMMARY

Various example embodiments provide a method and a device for generating random permutations using a manner capable of performing parallel processing while achieving or helping to achieve required complexity.

Alternatively or additionally various example embodiments provide a processor including a logic circuit generating random permutations in a manner capable of performing parallel processing while achieving required complexity.

According to some example embodiments, there is provided a processor including a controller configured to respectively assign different index numbers to a plurality of operations, a shuffling logic configured to perform a bitwise operation on each of the index numbers based on a modular addition operation and a rotation shift operation and to shuffle the index numbers, and an operation logic configured to perform the plurality of operations based on the shuffled index numbers.

Alternatively or additionally according to various example embodiments, an integrated circuit includes a processing logic configured to provide processing data on which an operation is to be performed, to a shuffling logic, and the shuffling logic configured to perform a bitwise operation on at least a portion of the processing data based on a modular addition operation and on a rotation shift operation.

Alternatively or additionally according to various example embodiments, an integrated circuit includes a processing logic configured to provide different pieces of processing data to a plurality of shuffling logics, and the plurality of shuffling logics configured to perform a bitwise operation on at least a portion of the processing data based on a modular addition operation and on a rotation shift operation. Output data of each of the plurality of shuffling logics may set a permutation in which the different pieces of processing data are shuffled.

Alternatively or additionally according to some example embodiments, a method of generating random permutations, performed by a processor of a computing device, includes receiving a plurality of key sets and basic permutation data set by a plurality of numbers, and shuffling numbers of the basic permutation data on each of the numbers of the basic permutation data by performing a bitwise operation based on a modular addition operation and on a rotation shift operation.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a block diagram illustrating a processor including a shuffling logic according to some example embodiments.

FIG. 2 is a diagram illustrating that a processor processes a plurality of operations based on random permutations, according to the example embodiment of FIG. 1.

FIG. 3 is a diagram illustrating a modular adder according to some example embodiments.

FIG. 4 is a diagram illustrating a rotation shift calculator according to some example embodiments.

FIG. 5 is a block diagram illustrating a shuffling circuit according to some example embodiments.

FIG. 6 is a block diagram illustrating a shuffling logic according to some example embodiments.

FIG. 7 is a block diagram illustrating an initial shuffling logic according to the example embodiment of FIG. 6.

FIG. 8 is a block diagram illustrating an intermediate shuffling logic according to the example embodiment of FIG. 6.

FIG. 9 is a diagram illustrating operations of a round key set and an intermediate shuffling logic according to the example embodiment of FIG. 6.

FIG. 10 is a block diagram illustrating a final shuffling logic according to the example embodiment of FIG. 6.

FIG. 11 is a block diagram illustrating a shuffling circuit according to some example embodiments.

FIG. 12 is a block diagram illustrating an intermediate shuffling logic according to some example embodiments.

FIG. 13 is a flowchart illustrating a method of generating random permutations according to some example embodiments.

FIG. 14 is a flowchart illustrating a shuffling operation in the method of generating random permutations according to the example embodiment of FIG. 13.

FIG. 15 is a flowchart illustrating an intermediate shuffling operation of the shuffling operation according to the example embodiment of FIG. 14.

### DETAILED DESCRIPTION

Hereinafter, various example embodiments will be described with reference to the accompanying drawings.

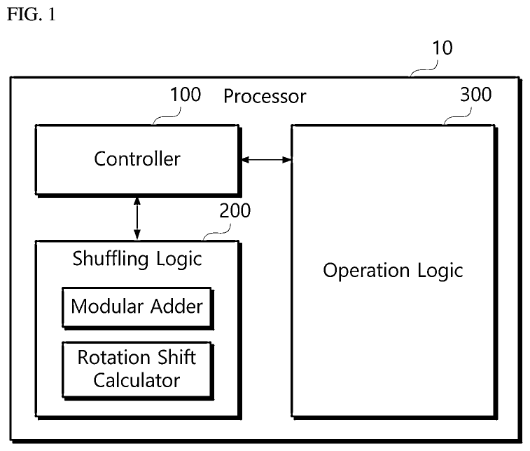

FIG. 1 is a block diagram illustrating a processor 10 according to some example embodiments. Referring to FIG. 1, the processor 10 may include a controller 100, a shuffling logic 200, and a calculation logic 300.

The processor 10 may be or may include, or may be included in, a processor used in a mobile device such as a smartphone and/or a tablet PC. Alternatively or additionally, the processor 10 may be or may include or be included in a processor used in a server device such as one or more of a security server, a data management server, or a cloud server.

The processor 10 may be or include a general-purpose processor such as an application processor (AP) and/or a central processing unit (CPU), or a specific-purpose secure processor performing encryption and decryption. When the processor 10 is a specific-purpose secure processor, the processor 10 may be disposed as a semiconductor chip, separate from an application processor (AP) and a central processing unit (CPU), or may be disposed as a part of a module inside the application processor (AP) and the central processing unit (CPU).

The controller 100 according to various example embodiments may transmit a command for generating random permutations to the shuffling logic 200.

In some example embodiments, the controller 100 may transmit a random permutation generation command to the shuffling logic 200, together with the number of required or expected elements of random permutation. For example, the controller 100 may transmit 6, which is the number of bit digits (or the bit size) of the number of elements of a random permutation including 64=2\hat{ }6 elements, and the random permutation generation command to the shuffling logic 200.

Alternatively or additionally, the controller 100 may assign index numbers to respective elements included in basic permutation data and transmit the assigned index numbers one by one to the shuffling logic 200. The number of the elements included in the basic permutation data may also be separately provided to the shuffling logic 200. Alternatively or additionally, each index number may be provided to the shuffling logic 200. For example, an index number “1” of the basic permutation data including 64 elements may be transmitted to the shuffling logic 200 as “00 00 01”.

The controller 100 may generate a plurality of keys to be used in the shuffling of the shuffling logic 200, and may provide the generated keys to the shuffling logic 200. A portion of the keys may have a size, different from a size of another portion of the keys. For example, the keys may include an initial key and a round key, and the number of bits in the initial key may be larger than the number of bits in the round key. The round key may include a plurality of key sets in which the same number of keys are included. The controller 100 may include a storage unit, capable of temporarily storing a plurality of keys.

The shuffling logic 200 may include a plurality of shuffling logics. Different shuffling logics or different shuffling logic operations may perform bitwise operations using different keys. A key may be used in a modular addition operation with processing data. The initial key and the round key may be randomly generated.

In some example embodiments, the controller 100 may assign an index number to each of a plurality of operations. The controller 100 may control the shuffling logic 200 such that the index numbers are shuffled to generate random permutations. Then, the operation logic 300 may perform a plurality of operations based on the shuffled index numbers.

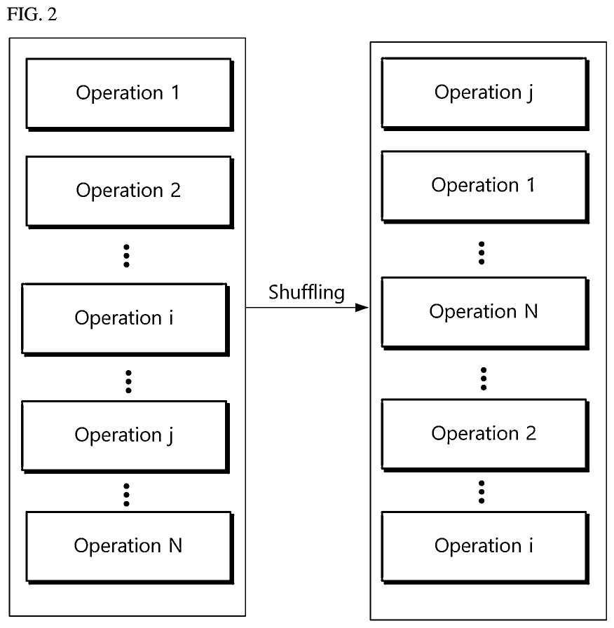

For example, referring to FIG. 2, the controller 100 may assign integers from index numbers 1 to N to respective N operations. The controller 100 may transmit the number of bits as log₂N, and may transmit a random permutation generation command to the shuffling logic 200. Alternatively or additionally, the controller 100 may transmit the number N of elements of the random permutation and a random permutation generation command to the shuffling logic 200. The shuffling logic 200 may shuffle binary bits of integers from 1 to N so as to output a permutation, such as for illustrative examples, {j, 1, . . . , N, 2, i} (2<i<j<N) sequentially and/or in parallel.

The controller 100 may sequentially reassign the example random permutation such as but not limited to {j, 1, . . . , N, 2, i}, generated by shuffling the N index numbers by the shuffling logic 200, to N operations as new index numbers. The operation logic 300 may perform operations based on the new index numbers. In this case, the operation logic 300 may perform operations serially, e.g., in the order of the new index number, and/or may group a plurality of operations based on the new index numbers and then process the grouped operations in parallel. Accordingly, at least some parallel vector operations of security algorithms may be randomized and performed, so that at least some hiding countermeasures against side-channel analysis (SCA) may be performed.

The shuffling logic 200 according to some example embodiments may perform a bitwise operation based on a modular addition operation and on a rotation shift operation on the processing data to output shuffled data. For example, the shuffling logic 200 may receive an integer i and may perform a bitwise operation based on a bit modular addition operation and a rotation shift operation on i binary bits to output j, where i and j may be different from each other.

The shuffling logic 200 may perform a rotation shift operation on a result of the modular addition operation. When the shuffling logic 200 performs a plurality of modular addition operations, a plurality of rotation shift operations may be performed. When a plurality of rotation shift operations are performed, the number of bits rotated and shifted in some rotation shift operations may be different from each other.

When a random permutation is generated from basic permutation data having N elements, the shuffling logic 200 may independently shuffle binary bits of the N elements. For example, when a random permutation is generated by shuffling the N elements according to a Fisher-Yates shuffle, one element of the random permutation may be determined, and then subsequently another element may be determined. Therefore, the elements of the random permutation may be sequentially determined. However, the shuffling logic 200 according to some example embodiments may independently determine the elements of the random permutation. Accordingly, the elements of the random permutation may be independently determined in the same clock period. For example, the shuffling logic 120 may shuffle each binary bit data of a plurality of pieces of processing data in the same clock period, regardless of other processing data. For example, the shuffling logic 200 may simultaneously and independently shuffle the i binary bits and (i+1) binary bits in the same clock period.

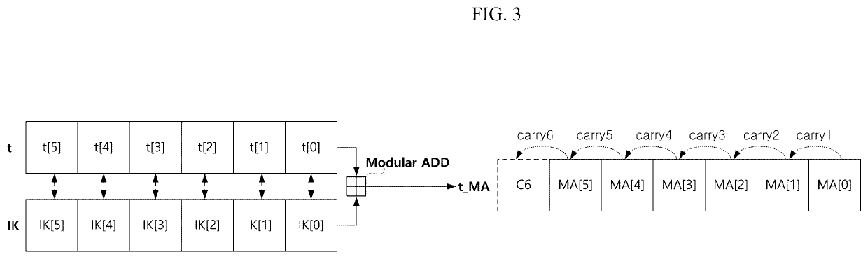

The modular addition operation of the shuffling logic 200 will be described below in more detail with reference to FIG. 3. FIG. 3 illustrates an operation in which the shuffling logic 200 performs a modular addition operation of processing data t and a key IK to output output data t_MA.

As described herein, the modular addition operation is represented by a symbol [symbol] ₖ(t) The modular addition operation symbol [symbol] ₖ(t) is defined as (k+t) mod N, and N is defined as 2ⁿ for n bits of the processing data t. For example, N may be the number of integers that can be represented with n, the number of bits. In addition, k represents a key. Accordingly, the shuffling logic 200 may perform a modular addition operation on at least a portion of the processing data, provided from the controller 100, and the key.

Referring to FIG. 3, the processing data t is, for example, a binary bit sequence having 6-bit digits and is represented with six bits from a most significant bit t[5] to a least significant bit t[0]; however, example embodiments are not limited to six bits. The processing data t and the key IK, upon which the modular addition operation is to be performed, are a binary bit sequence having the same number of bits as the processing data t. The key IK is represented with six bits from a most significant bit MSB IK[5] to a least significant bit IK[0]. Accordingly, N used to obtain a remainder of the modular addition operation is 64.

Each bit of the binary digits of the processing data t is added to a bit of a corresponding bit digit of the key IK. Therefore, t[5] is added to IK[5], t[4] is added to IK[4], t[3] is added to IK[3], t[2] is added to IK[2], t[1] is added to IK[1], and t[0] is added to IK[0]. Addition of bits in each digit may generate a carry bit in an upper bit digit. The addition of bits is performed with a carry bit included. A most significant bit C6 of a result of the binary bit addition operation of the processing data t and the key IK is discarded. Thus, the output data t_MA becomes a remainder by N=64.

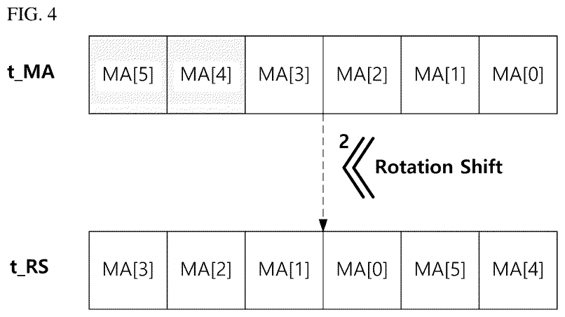

A rotation shift operation of the shuffling logic 200 will be described below in more detail with reference to FIG. 4. FIG. 4 illustrates an operation in which the shuffling logic 200 performs a 2-bit rotation shift operation on data t_MA to output output data t_RS.

As described herein, the rotation shift operation is represented by a symbol [symbol] or [symbol] . The symbols [symbol] and [symbol] refer to a rotation shift operation by S bits in a left direction (a more significant direction) and a rotation shift operation by S bits in a right direction (a less significant direction), respectively. Bits, shifted to exceed a most significant bit digit, are sequentially rotated and shifted to a least significant bit digit. Accordingly, when a rotation shift operation is performed on data having n bit digits, the data may return to itself regardless of direction, e.g., after n such rotations.

Referring to FIG. 4, the processing data t_MA is a binary bit sequence having 6 bit digits and is represented with six bits from a most significant bit t_MA [5] to a least significant bit t_MA [0]. When a rotation shift operation is performed by two bits to the left, t_MA [5] and t_MA [4] are sequentially rotated and shifted to a least significant bit.

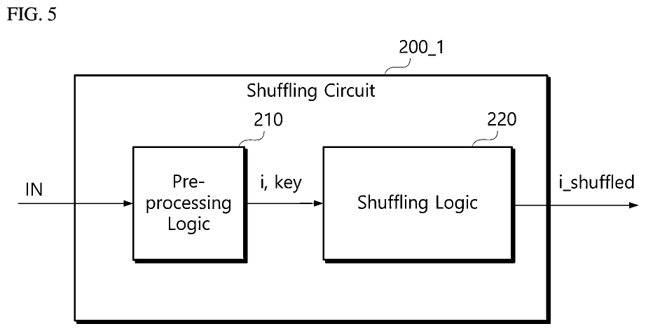

FIG. 5 is a block diagram illustrating a shuffling circuit according to some example embodiments. A shuffling circuit 200_1 may include a processing logic such as a preprocessing logic 210, and a shuffling logic 220.

The preprocessing logic 210 may receive input data IN and may provide the shuffling logic 220 with processing data i to be shuffled along with at least one key to be used for a modular addition operation.

In some example embodiments, the input data IN may include processing data i and a key. In this case, the preprocessing logic 210 may include a flip-flop (such as one or more D flip-flops) and may provide the processing data i and the key to the shuffling logic 220 in synchronization with a clock signal.

In some example embodiments, the input data IN may be the number of numbers required or used for random permutation. For example, when a random permutation including 64 numbers is required or used, the preprocessing logic 210 may sequentially provide processing data i including six bits to the shuffling logic 220. Alternatively or additionally, a plurality of pieces of processing data may be provided to the plurality of shuffling logics 220 in parallel, respectively.

According to some example embodiments, the preprocessing logic 210 may include a key generator. The key generator may be a random number generator generating random keys. In this case, the preprocessing logic 210 may generate a plurality of keys, different from each other, and may provide the generated keys to the shuffling logic 220. In some example embodiments, the key generator may be a post-quantum key generator; example embodiments are not limited thereto.

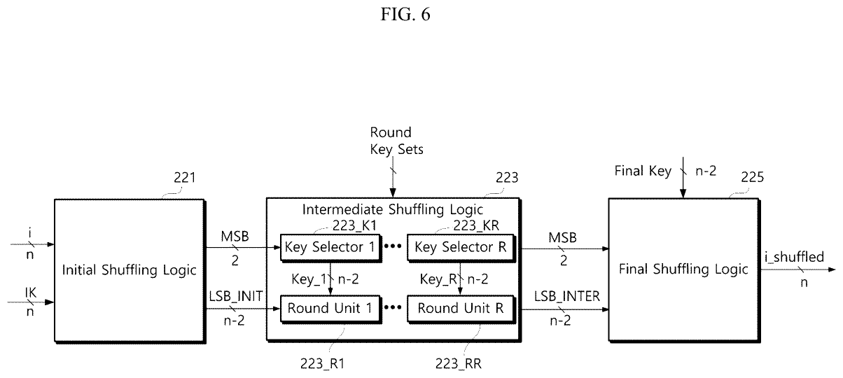

FIG. 6 is a block diagram illustrating a shuffling logic according to some example embodiments. Referring to FIG. 6, a shuffling logic 220 may include an initial shuffling logic 221, an intermediate shuffling logic 223, and a final shuffling logic 225. Each of the shuffling logics 221, 223, 225 may include at least one modular adder and at least one rotation shift operator. Some shuffling logics may each include a plurality of modular adders and a plurality of rotation shift operators.

The shuffling logic 220 may receive processing data i including n bits, and may shuffle at least a portion of the n bits and output shuffled data i_shuffled including n bits.

The initial shuffling logic 221 may be provided with an initial key IK. The initial shuffling logic 221 will be described in detail with reference to FIG. 6.

The initial shuffling logic 221 may divide a result of shuffling the binary data of the processing data i into a plurality of blocks MSB and LSB_INIT and provide each of the blocks MSB and LSB_INIT to the intermediate shuffling logic 223.

The intermediate shuffling logic 223 may include a plurality of key selectors 223_K1 to 223_KR as well as a plurality of round units 223_R1 to 223_RR.

Each of the plurality of round units 223_R1 to 223_RR may include at least one modular adder and at least one rotation shift operator.

The intermediate shuffling logic 223 may be provided with keys to be used in modular addition operations of a plurality of round units 223_R1 to 223_RR. The keys provided to the intermediate shuffling logic 223 may include a plurality of key sets. The key sets may be referred to as round key sets. Each of the round key sets may include a plurality of round keys. The round keys may be randomly generated keys.

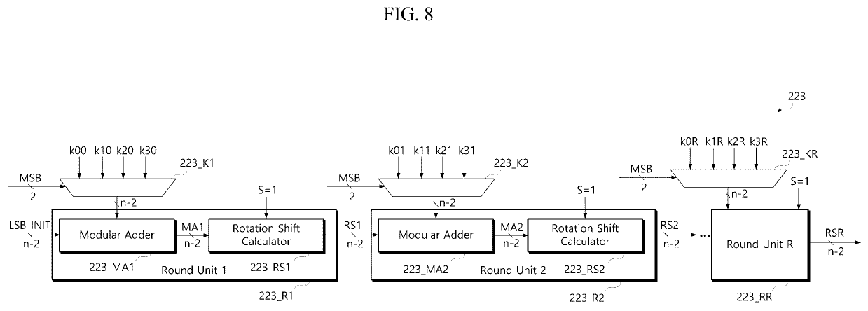

In some example embodiments, the round key set may include a number of keys, such as four round key sets. This will be described in detail with reference to FIG. 8.

Each of the key selectors 223_K1 to 223_KR of the intermediate shuffling logic 223 may select a single round key, from among round keys to be used in a modular addition operation, based on a first block MSB among the plurality of blocks MSB and LSB_INIT provided by the initial shuffling logic 221. In some example embodiments, the first block MSB may include most significant 2 bits of a result of shuffling the processing data i by the initial shuffling logic 221.

Each of the plurality of round units 223_R1 to 223_RR of the intermediate shuffling logic 223 may perform a modular addition operation on an output result of a previous round unit and the selected round keys Key_1 to Key_R based on the first block MSB. For example, the first round unit 223_R1 may perform a modular addition operation on the second block LSB_INIT, provided by the initial shuffling logic 221, and the round key Key_1 selected by the first key selector 223_K1. The second block LSB_INIT may include remaining bits excluding the most significant 2 bits from the result of shuffling the processing data i by the initial shuffling logic 221. The first round unit 223_R1 may perform a rotation shift operation on the result of the modular addition operation, and may provide the result to a next round unit.

The final shuffling logic 225 may receive a first block MSB and a second block LSB_INTER from the intermediate shuffling logic 223. The first block MSB, provided to the final shuffling logic 225, is the same as the first block MSB provided to the intermediate shuffling logic 223.

The final shuffling logic 225 is provided with a final key. The final shuffling logic 225 may perform a modular addition operation on the second block LSB_INTER and the final key.

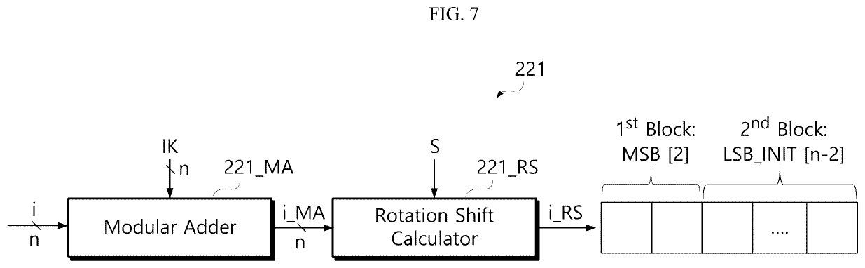

The initial shuffling logic will be described below in detail with reference to FIG. 7. The initial shuffling logic 221 may include a modular adder 221_MA performing an n-bit modular addition operation.

The modular adder 221_MA may perform a modular addition operation on n bits of processing data i and on n bits of initial key IK, and may provide n bits of output i_MA to a rotation shift operator 221_RS. The modular addition operation may be performed as described in FIG. 3. The initial key IK may be provided from the controller 100 or the preprocessing logic 210. The initial key IK may be randomly generated. In some example embodiments, the initial key IK may be generated with a post-quantum cryptography protocol; example embodiments are not limited thereto.

The rotation shift operator 221_RS may perform a rotation shift operation by S bits on the provided i_MA. The number of bit digits S to be rotated and shifted may be randomly determined. The rotation shift operator 221_RS may receive the number of bit digits S from the preprocessing logic 210 and/or from the controller 100. In some example embodiments, the rotation shift operator 221_RS of the initial shuffling logic 221 may perform a rotation shift operation in a left direction (e.g., in a more significant bit direction).

The initial shuffling logic 221 may divide a result of performing the rotation shift operation i_RS into two blocks MSB[2] and LSB_INIT[n-2], and may provide each of the blocks MSB[2] and LSB_INIT[n-2] to the intermediate shuffling logic 223. A first block MSB[2] may include the two most significant bits of a result i_RS of performing the rotation shift operation, and a second block LSB_INIT[n-2] may include a remainder excluding two most significant bits from the result i_RS of performing the rotation shift operation.

The intermediate shuffling logic will be described below in detail with reference to FIG. 8.

The intermediate shuffling logic 223 according to some example embodiments may include R round units 223_R1 to 223_RR and R key selectors 223_K1 to 223_KR. Each of the round units 223_R1 to 223_RR may perform a shuffling operation. The shuffling operation may include a modular addition operation using a modular adder and a rotation shift operation using a rotation shift operator.

The intermediate shuffling logic 223 may include a plurality of key selectors 223_K0 to 223_K1 and a plurality of round units 223_R1 to 223_RR. Each of the plurality of round units 223_R1 to 223_RR may include a modular addition operator and a rotation shift operator. For example, a first round unit 223_R1 may include a first modular addition operator 223_MA1 and a first rotation shift operator 223_RS1. A second round unit 223_R2 may include a second modular addition operator 223_MA2 and a second rotation shift operator 223_RS2. A final round unit 223_RR may include an R-th modular addition operator and an R-th rotation shift operator.

The plurality of round units 223_R1 to 223_RR may receive a round key from corresponding key selectors 223_K1 to 223_KR, respectively. Each of the plurality of key selectors 223_K1 to 223_KR may select a round key based on the first block MSB provided from the initial shuffling logic 221. The plurality of key selectors 223_K1 to 223_KR may select a round key based on the same first block MSB. In some example embodiments, the key selectors 223_K1 to 223_KR may select a single round key, among four round keys, based on 2 bits of first block MSB.

The first round unit 223_R1 may perform a modular addition operation on n-2 bits of second block LSB_INIT, provided from the initial shuffling logic 221, and n-2 bits of round key provided from the key selector 223_K1. The first round unit 223_R1 may perform a rotation shift operation on a modular addition operation result MA1, and may provide a rotation shift operation result RS1 to a next round unit.

Round units, subsequent to the first round unit 223_R1, may perform a modular addition operation on a rotation shift operation result of a previous round unit and a round key provided from a corresponding key selector, and may perform a rotation shift operation on a modular addition operation result. A result of performing the rotation shift operation may be provided to a next round unit.

The modular addition operator of each of the plurality of round units 223_R1 to 223_RR may perform a modular addition operation on n-2 bits of processing data, provided from a previous unit, and n-2 bits of round key. Modular addition may be performed on n-2. Therefore, when the processing data i input to the shuffling logic 220 is n=6 bits, most significant 2 bits may be used for round key selection, and the remaining 4 bits may be used for a modular addition operation on 16.

In some example embodiments, a portion of the rotation shift operators 223_RS1 to 223_RR of the plurality of round units 223_R1 to 223_RR may perform a 1-bit rotation shift operation in a left direction, and the remainder may perform a 1-bit (single bit) rotation shift operation in a right direction. For example, among the plurality of round units 223_R1 to 223_RR, first R/2 rotation shift operators may perform a 1-bit rotation shift operation in the left direction, and remaining R/2 rotation shift operators may perform a 1-bit rotation shift operation in the right direction.

The number of shuffling operations performed by the intermediate shuffling logic 223 may be preset based on the number of bit digits and complexity of processing data input to the shuffling logic 220. The complexity may be or may correspond to the degree of complexity required or used for security specifications and/or hiding countermeasures.

For example, the number of shuffling operations performed by the intermediate shuffling logic 223 may be preset as illustrated in Table 1, based on the number of bit digits (bit size) and complexity of the processing data input to the shuffling logic 220.

Referring to Table 1, when the processing data is 6 bits and complexity of 228 is required, a shuffling operation may be performed 8 times in the intermediate shuffling logic 223. Accordingly, the shuffling logic 223 may include eight round units.

TABLE 1

| Input size(bits) | 4 | 5 | 6 | 7 | 8 | 9 | 10 |
|---|---|---|---|---|---|---|---|
| Required Rounds for H(X) = 2²⁸ | 14 | 10 | 8 | 6 | 6 | 6 | 4 |
| Required Rounds for H(X) = 2³² | 16 | 12 | 10 | 8 | 6 | 6 | 6 |
| Required Rounds for H(X) = 2³⁶ | 20 | 14 | 12 | 10 | 8 | 8 | 6 |

The complexity H(X) refers to complexity of computing operation on a random variable X, and may be based on the product of probability of a random variable p(x) and a log scale log(p(x)).

$$H ( X ) = - \sum p ( x ) log ( p ( x ) ) \qquad Equation 1$$

In some example embodiments, the intermediate shuffling logic 223 may only perform half of the number of shuffling operations in Table 1, based on processing data and required complexity. Accordingly, the shuffling logic 223 may include round units corresponding to half the number of shuffling operations in Table 1. In this case, the rotation shift operators of each round unit of the shuffling logic 223 may be operators that only perform a 1-bit rotation shift operation in the left direction. For example, when there is a random permutation having a symmetrical structure, the required complexity may be achieved even when only half of the number of shuffling operations in Table 1 is performed. Accordingly, when a random permutation has a symmetrical structure, desired complexity and/or security may be achieved or may be more likely to be achieved with only a small number of round units of the intermediate shuffling logic 223.

The key selectors 223_K1 to 223_KR according to some example embodiments may select one of a plurality of keys as a round key based on the first block MSB provided by the initial shuffling logic 221.

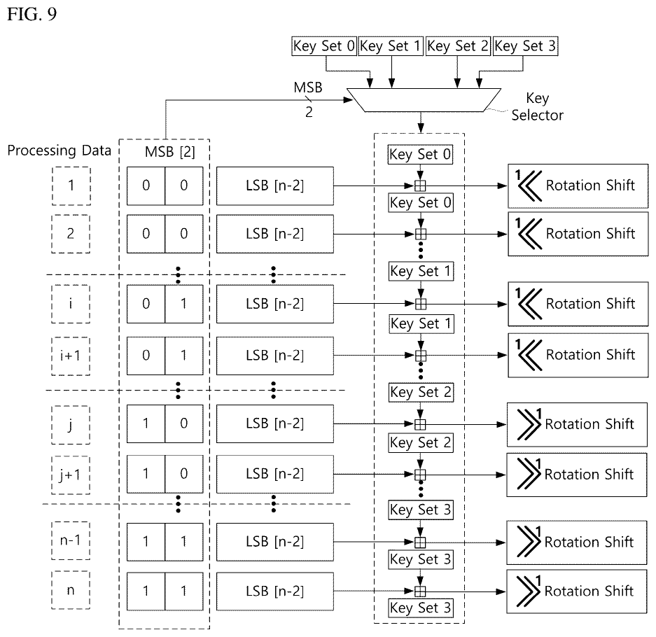

Referring to FIG. 9, in some example embodiments, the intermediate shuffling logic 223 may be provided with four round key sets Key Set 0, Key Set 1, Key Set 2, and Key Set 3. Each of the round key sets Key Set 0, Key Set 1, Key Set 2, and Key Set 3 may include R keys corresponding to the number of shuffling operations of the intermediate shuffling logic 223.

For example, a first round key set Key Set 0 may include R keys {k01, k02 to k0R}. Similarly, a second round key set Key Set 1 may include R keys {k11, k12 to k1R}. A third round key set Key Set 2 and a fourth round key set Key Set 3 may be similar thereto.

Keys included in each of the round key sets Key Set 0, Key Set 1, Key Set 2, and Key Set 3 may be randomly generated. The round key sets Key Set 0, Key Set 1, Key Set 2, and Key Set 3 may be generated by the preprocessing logic 210 and/or the controller 100.

The key selector may select a round key set of one of the four round key sets Key Set 0, Key Set 1, Key Set 2, and Key Set 3, based on most significant 2 bits MSB[2] of the processing data. The key selector may provide a round key corresponding to a round unit, among R keys included in the selected round key set.

For example, a portion of n pieces of processing data may be subjected to a modular addition operation with each of the round keys of the first round key set Key Set 0, based on most significant 2 bits (MSB[2]) “00.” Another portion of n pieces of processing data may be subjected to a modular addition operation with each of the round keys of the second round key set Key Set 1, based on most significant 2 bits (MSB[2]) “01.” Another portion of n pieces of processing data may be subjected to a modular addition operation with each of the round keys of the third round key set Key Set 2, based on most significant 2 bits (MSB[2]) “10.” The remaining portion of n pieces of processing data may be subjected to a modular addition operation with each of the round keys of the fourth round key set Key Set 3, based on most significant 2 bits (MSB[2]) “11.”

Returning to FIG. 8, each of the plurality of key selection keys 223_K1 to 223_KR may be provided with four keys corresponding to a round unit, among the keys of the four round key sets Key Set 0, Key Set 1, Key Set 2, and Key Set 3. Each of the plurality of key selection keys 223_K1 to 223_KR may select one of the four keys based on the most significant 2 bits MSB[2], and may provide the select key to the corresponding round unit.

The intermediate shuffling logic 223 may increase complexity by selecting a round key based on the most significant bits of the processed data.

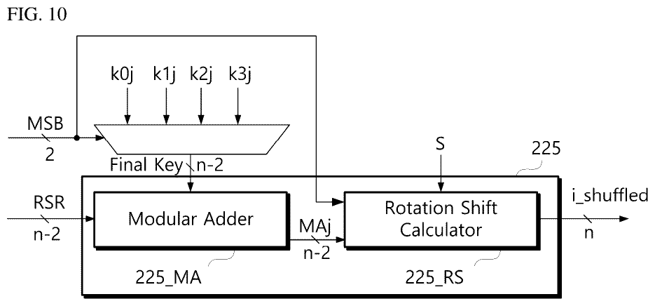

The final shuffling logic will be described below in detail with reference to FIG. 10. The final shuffling logic 225 may include a modular adder 225_MA and a rotation shift operator 225_RS.

The modular adder 225_MA may perform a modular addition operation on n-2 bits of processing data RSR and n-2 bits of final key provided by the intermediate shuffling logic 223. Similarly to the intermediate shuffling logic 223, one of a plurality of keys k0j, k1j, k2j, and k3j may be selected as the final key, based on the first block MSB[2] provided by the initial shuffling logic 221.

The modular adder 225_MA may provide n-2 bits of output Maj to the rotation shift operator 225_RS. The modular addition operation may be performed as described in FIG. 3. The final key may be provided from the controller 100 or the preprocessing logic 210. The final key may be randomly generated.

The rotation shift operator 225_RS may configure the provided Maj as lower bits, and may perform an S-bit rotation shift operation on data with the first block MSB[2] configured as most significant bits. For example, the rotation shift operator 225_RS may merge the first block MSB[2] and the provided Maj, and may then perform the rotation shift operation.

The number of bit digits S rotated and shifted may be randomly determined. The rotation shift operator 225_RS may receive the number of bit digits S from the preprocessing logic 210 or the controller 100. In some example embodiments, the rotation shift operator 221_RS of the final shuffling logic 225 may perform a rotation shift operation in a right direction.

The final shuffling logic 225 may output data i_shuffled in which binary bits of the processing data I received by the shuffling logic 220 are shuffled.

The shuffling circuit 200_1, described with reference to FIGS. 5 to 10, may shuffle binary bits of input processing data to output elements constituting a random permutation. Accordingly, the elements constituting the random permutation may be generated independently of each other. For example, unlike the Fisher-Yates shuffle, the elements constituting the random permutation are generated independently of each other, so that a large storage space is not required or is not likely to be used. Additionally or alternatively, random permutations may be generated in a small amount of time.

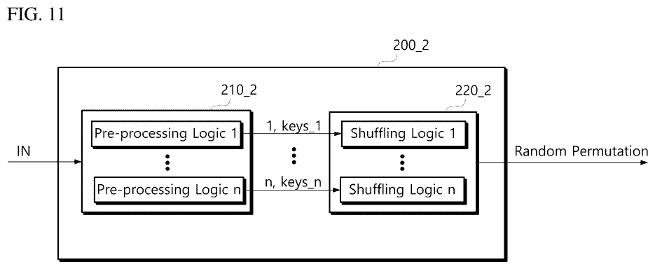

FIG. 11 is a block diagram illustrating a shuffling circuit according to some example embodiments. A shuffling circuit 200_2 may include a preprocessing logic unit 210_2 and a shuffling logic unit 220_2. The preprocessing logic unit 210_2 may include a plurality of preprocessing logics Preprocessing Logic 1 to Preprocessing Logic n, and the shuffling logic unit 220_2 may include a plurality of shuffling logics Shuffling Logic 1 to Shuffling Logic n.

Similarly to the description provided with reference to FIG. 5, the preprocessing logic unit 210_2 may receive processing data {1, . . . , n} and keys {keys_1 to keys_n} as input data IN. In this case, the preprocessing logic unit 210_2 may include a plurality of flip-flops, and may provide each of the processing data {1, . . . , n} and the keys {keys_1 to keys_n} to a corresponding shuffling logic in synchronization with a clock signal.

In some example embodiments, the input data IN may be the number of numbers required for random permutation. For example, when generation of a random permutation including 64 numbers is requested, each of the preprocessing logics Preprocessing Logic 1 to Preprocessing Logic n of the preprocessing logic unit 210_2 may process 6 bits of data. A plurality of pieces of the processing data {1, . . . , n} may be provided in parallel to corresponding shuffling logics Shuffling Logic 1 to Shuffling Logic n, respectively. Each of the plurality of shuffling logics Shuffling Logic 1 to Shuffling Logic n may independently shuffle binary bits of the input processing data. Each of the plurality of shuffling logics Shuffling Logic 1 to Shuffling Logic n may perform shuffling operations in the same clock period.

Output data of each of the plurality of shuffling logics Shuffling Logic 1 to Shuffling Logic n of the shuffling circuit 200_2 may constitute a random permutation in which the plurality of pieces of the processing data {1, . . . , n} are randomly shuffled.

Accordingly, unlike Fisher-Yates shuffle, random permutations may be generated in a significantly small amount of time. In addition, a plurality of shuffling logics operates independently of each other, so that a large storage space may not be required.

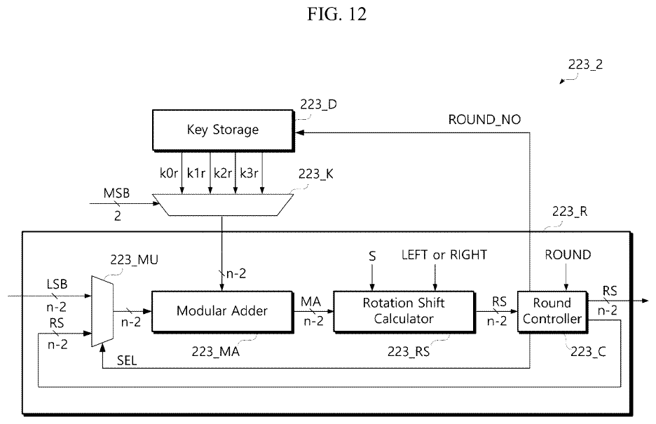

FIG. 12 is a block diagram illustrating an intermediate shuffling logic according to some example embodiments.

Referring to FIG. 12, an intermediate shuffling logic 223_2 may include a key storage unit 223_D, a key selector 223_K, and a round unit 223_R.

Unlike example embodiments of the intermediate shuffling logic 223_1 described with reference to FIG. 8, the intermediate shuffling logic 223_2 of FIG. 12 may include the round unit 223_R having a recursive construction.

The key storage unit 223_D may include a plurality of round key sets. Each of the plurality of round key sets may store a plurality of round keys. Each of the plurality of round key sets may store a number of round keys corresponding to a number of rounds (such as a predetermined number of rounds) ROUND.

The key storage unit 223_D may receive a round to be performed ROUND_NO, among the number of rounds ROUND, and may provide corresponding round keys k0r, k1r, k2r, and k3r of each round key set to the key selector 223_K.

The key selector 223_K may select a single round key from among the plurality of keys provided k0r, k1r, k2r, and k3r based on the first block MSB provided to the initial shuffling logic, and may provide the selected round key to the round unit 223_R.

The round unit 223_R may include a multiplexer 223_MU, a modular adder 223_MA, a rotation shift operator 223_RS, and a round controller 223_C.

The round controller 223_C may determine whether to additionally perform a round based on the number of performed rounds, among the number of rounds ROUND. When the number of rounds ROUND is completed, the round controller 223_C may provide an output RS, provided by the rotation shift operator 223_RS, to a final shuffling unit. When the number of rounds ROUND is not completed, the round controller 223_C may provide the output RS, provided by the rotation shift operator 223_RS, to the multiplexer 223_MU.

The multiplexer 223_MU may select either one of a second block LSB, provided by an initial shuffling unit, and an output RS, provided by the rotation shift operator 223_RS, and may provide the selected LSB or RS to the modular adder 223_MA. The multiplexer 223_MU may select one of the second block LSB and the output RS as an input to the modular adder 223_MA based on a select signal SEL provided by the round controller 223_C.

The modular adder 223_MA performs a modular addition operation on one of the second block LSB and the output RS and the round key provided by the key selector 223_K. The modular adder 223_MA may provide a result MA of the modular addition operation to the rotation shift operator 223_RS.

The rotation shift operator 223_RS may receive a direction LEFT or RIGHT of the rotation shift operation, and may perform an S-bit rotation shift operation on the result MA of the modular addition operation. According to some example embodiments, the rotation shift operator 223_RS may perform a 1-bit rotation shift operation. The rotation shift operator 223_RS may provide a result RS of the rotation shift operation to the round controller 223_C.

Accordingly, the intermediate shuffling logic 223_2 according to the example embodiment of FIG. 12 may shuffle a plurality of rounds based on the intermediate shuffling logic having a small area.

According to some example embodiments, the intermediate shuffling logic 223_2 may be provided in plural, as described in FIG. 11.

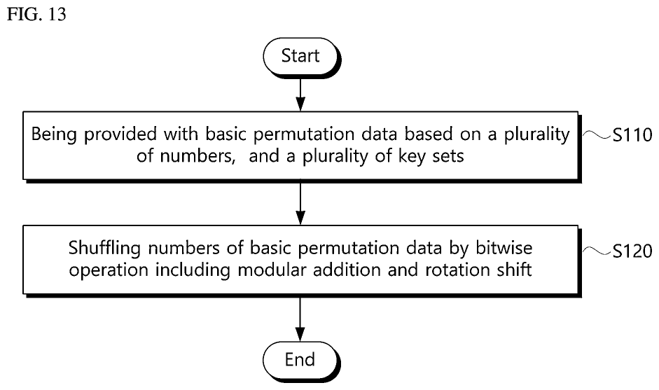

FIG. 13 is a flowchart illustrating a method of generating random permutations according to some example embodiments.

The method of generating random permutations according to some example embodiments may be performed by the processor of FIG. 1 and the shuffling circuit described in FIGS. 5 and 11.

The shuffling circuit may shuffle a plurality of elements of basic permutation data, to generate a random permutation. The shuffling circuit may process a plurality of numbers, elements of basic permutation data, in parallel independently of each other to shuffle the processed numbers.

Alternatively, the shuffling circuit may sequentially receive a plurality of numbers, elements of basic permutation data, and may shuffle binary bits of each of the numbers to output numbers constituting a random permutation.

In operation S110, the shuffling circuit may receive basic permutation data and a plurality of key sets.

Elements of the basic permutation data may be a plurality of non-overlapping numbers. In this case, the shuffling circuit may generate and shuffle index numbers corresponding to the elements of the basic permutation data.

In some example embodiments, the elements of the basic permutation data may be a sequence of index numbers.

When the basic permutation data is X={x₀, x₁, x₂, . . . , x_{N-1}}, the shuffled and output random permutation may be Y={y₀, y₁, y₂, . . . , y_{N-1}}, where yi and yj are different from each other, and i and j are different from each other.

The shuffling circuit may be provided with a plurality of keys and the number of rounds R.

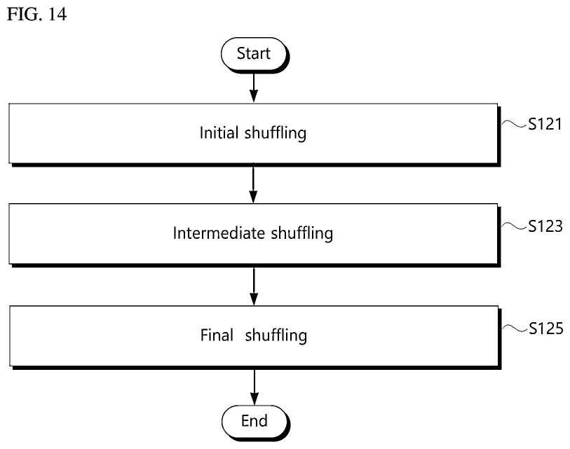

The shuffling circuit may be provided with the number of rounds R together with the basic permutation data. The number of rounds R is the number of rounds performed in the intermediate shuffling operation described with reference to FIG. 14. The number of rounds R may be preset based on the number of bit digits (bit size) and complexity of the basic permutation data. The complexity may be the degree of complexity required for security specifications and/or hiding countermeasures. The number of rounds R may be selected based on Table 1 described above.

The plurality of keys may include a plurality of round keys used for each round. For example, a single key set may be K={k₀, k₁, . . . , k_{R}} including R round keys, used in R rounds of the intermediate shuffling operation, and a final key used in the final shuffling operation. The key set may be provided in plural.

In operation S120, the shuffling circuit may shuffle the elements of the basic permutation data by performing a modular addition operation and a rotation shift operation on the basic permutation data.

The modular addition operation and rotation shift operation may be bitwise operations, and may be performed on each of the elements of the basic permutation data.

For example, a bitwise operation may be performed on each of the elements of the basic permutation data X={x₀, x₁, x₂, . . . , x_{N-1}}, and a result of performing the bitwise operation on each of the elements may constitute elements of a random permutation.

The modular addition operation may be described as illustrated in FIG. 3. The keys provided in operation S110 may be used for the modular addition operation. The rotation shift operation may be described as illustrated in FIG. 4.

FIG. 14 is a flowchart illustrating the shuffling operation in operation S120 of the method of generating random permutations according to the example embodiment of FIG. 13.

The shuffling circuit may perform an initial shuffling operation, an intermediate shuffling operation, and a final shuffling operation.

In operation S121, the shuffling circuit may perform a modular addition operation on processing data (a single element of the basic permutation data X={x₀, x₁, x₂, . . . , x_{N-1}} and an initial key. The shuffling circuit may perform an S-bit rotation shift operation on a result of the modular addition operation. The S bits may be randomly determined. The initial key may be a randomly generated key of n bits (log N). The shuffling circuit may perform a rotation shift operation in a left direction.

The shuffling circuit may divide a result of the rotation shift operation in operation S121 into two blocks (a first block and a second block), and may provide the two blocks to an intermediate shuffling operation.

In operation S123, the shuffling circuit may perform R round shuffling operations based on the second block. Each round shuffling operation may be performed by a modular addition operation and a rotation shift operation. According to some example embodiments, the shuffling circuit may achieve required complexity with R/2 round shuffling operations.

The round keys of the key set K={k₀, k₁, . . . , k_{R}}, provided in operation S110, may be used in the modular addition operation of each round shuffling operation.

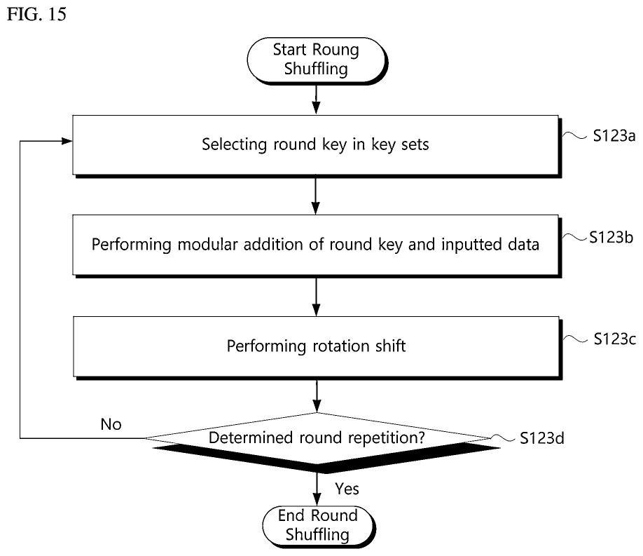

The round shuffling operation will be described below in detail with reference to FIG. 15.

In operation S123a, among a plurality of key sets, a single key set may be selected based on the first block provided in operation S121. Each key set may include R round keys and a final key used in the final shuffling operation.

In operation S123b, a modular addition operation may be performed on a round key corresponding to each round operation, among round keys of the selected key set, and an operation result provided in the previous round operation.

In operation S123c, an S-bit rotation shift operation may be performed on the result of the modular addition operation. According to some example embodiments, a 1-bit rotation shift operation may be performed.

A portion of a total of R round shuffling operations may be a rotation shift operation performed in a left direction, and another portion may be a rotation shift operations performed in a right direction. For example, a rotation shift operation may be performed in a left direction in the first half of the round shuffling operation, and a rotation shift operation may be performed in a right direction in the second half of the round shuffling operation, for a total of R round shuffling operations.

In operation S123d, when the round shuffling operation is performed a number of times (such as a predetermined) number of times, the shuffling circuit may stop the round shuffling operation.

While FIG. 15 has been described on the premise that a round shuffling operation is repeatedly performed in a single round unit in a recursive manner, the round shuffling operation may be performed continuously in a plurality of round units according to example embodiments.

Returning to FIG. 14, in operation S125, the shuffling circuit may perform a final shuffling operation. The final shuffling operation may include a modular addition operation and a rotation shift operation.

The shuffling circuit may perform a modular addition operation on an operation result in the intermediate shuffling operation S123 and the final key. The shuffling circuit may perform a rotation shift operation on a result of the modular addition operation. The rotation shift operation in the final shuffling operation S125 may be performed on data obtained by merging the result of the modular addition operation and the first block. The shuffling circuit may perform an S-bit rotation shift operation on a result of the modular addition operation. The S bit may be randomly determined. The shuffling circuit may perform a rotation shift operation in a right direction.

As set forth above, a method and a device for generating random permutations according to some example embodiments may generate random permutations using a manner capable of performing parallel processing while achieving or helping to achieve required or desired complexity.

Alternatively or additionally, a method and a device for generating random permutations according to various example embodiments may process a plurality of operations in parallel based on random permutations generated in a manner capable of performing parallel processing, while achieving or helping to achieve required or desired complexity.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While various example embodiments have been shown and described above, it will be apparent to those of ordinary skill in the art that modifications and variations could be made without departing from the scope of the present inventive concept as defined by the appended claims. Additionally example embodiments are not necessarily mutually exclusive with one another. For example, some example embodiments may include one or more features described with reference to one or more figures, and may also include one or more other features described with reference to one or more other figures.

What is claimed is:

1. A processor comprising:
a controller configured to respectively assign different index numbers to a plurality of operations;
a shuffling logic configured to perform a bitwise operation on each of the index numbers based on a modular addition operation and a rotation shift operation;
to shuffle the index numbers; and
an operation logic configured to perform the plurality of operations based on the shuffled index numbers.

2. The processor of claim 1, wherein the shuffling logic comprises at least one round unit,
the at least one round unit is configured to perform a shuffling operation comprising the modular addition operation on a round key, provided input data, and the rotation shift operation, and
a number of times the shuffling operation is performed is set based on a number of bit digits of the index numbers and on a set complexity.

3. An integrated circuit comprising:
a processing logic configured to provide processing data, on which at least one operation is to be performed, to a shuffling logic; and
the shuffling logic configured to perform a bitwise operation on at least a portion of the processing data based on a modular addition operation and on a rotation shift operation.

4. The integrated circuit of claim 3, wherein the shuffling logic comprises a first logic unit configured to output first data by performing a modular addition operation on the processing data and on a random initial key and to output second data by performing a rotation shift operation on the first data in a left direction.

5. The integrated circuit of claim 4, wherein
the shuffling logic comprises a plurality of round units and a plurality of key selection units configured to respectively provide round keys to the plurality of corresponding round units,
the shuffling logic is configured to divide the second data into a first block and a second block,
each of the plurality of key selection units is configured to select the round key from among a plurality of keys, based on the first block, and
each of the plurality of round units is configured to perform a modular addition operation on input data and on the round key and to perform rotation shift operation on a result of the modular addition operation of the input data and the round key.

6. The integrated circuit of claim 5, wherein
the plurality of round units comprise an initial round unit and an intermediate round unit,
the initial round unit is configured to receive the second block as the input data, and
the intermediate round unit is configured to receive an output of the initial round unit as the input data.

7. The integrated circuit of claim 6, comprising:
a second logic unit configured to calculate final initial data based on an output of the intermediate round unit, wherein
the second logic unit comprises,
a modular adder configured to perform a modular addition operation on the round key, selected from among a plurality of keys, and on the output of the intermediate round unit based on the first block; and
a rotation shift calculator configured to perform a rotation shift operation on a result of merging an output of the modular adder and the first block in a right direction, the rotation shift calculator configured to calculate the output data.

8. The integrated circuit of claim 3, wherein
the shuffling logic comprises a plurality of shuffling logics,
each of the plurality of shuffling logics is configured to receive different pieces of the processing data and to output output data with at least one bit shuffled, and
the output data of each of the plurality of shuffling logics corresponds to a permutation in which different pieces of the processing data are randomly shuffled.

9. An integrated circuit comprising:
a processing logic configured to provide different pieces of processing data to a plurality of shuffling logics; and
the plurality of shuffling logics configured to perform a bitwise operation on at least a portion of the processing data on a modular addition operation and on a rotation shift operation, wherein
output data of each of the plurality of shuffling logics sets a permutation in which the different pieces of processing data are shuffled.

10. The integrated circuit of claim 9, wherein each of the plurality of shuffling logics is configured to perform bitwise operations on the processing data independently of each other.

11. The integrated circuit of claim 9, wherein each of the plurality of shuffling logics is configured to perform bitwise operations in the same clock period.

12. A method of generating random permutations, performed by a processor of a computing device, the method comprising:
receiving a plurality of key sets and basic permutation data set by a plurality of numbers; and
shuffling numbers of the basic permutation data by performing a bitwise operation based on a modular addition operation and on a rotation shift operation on each of the numbers of the basic permutation data.

13. The method of claim 12, wherein
the bitwise operation is independently performed on each of the numbers of the basic permutation data.

14. The method of claim 12, wherein the shuffling the numbers of the basic permutation data comprises:
an initial shuffling operation of performing a first modular addition operation and a first rotation shift operation, the first modular addition operation and the first rotation shift operation based on the number of bit digits of a number of the basic permutation data;
an intermediate shuffling operation of performing a second modular addition operation and a second rotation shift operation, the second modular addition operation and the second rotation shift operation based on the number of digits of a portion of bit blocks of the number of the basic permutation data; and
a final shuffling operation of performing a third modular addition operation based on the number of the digits of the portion of the bit blocks, and performing a third rotation shift operation based on the number of the bit digits of the number of the basic permutation data.

15. The method of claim 14, wherein
a result of the initial shuffling operation is divided into a first block and a second block, and the first block and the second block are provided to the intermediate shuffling operation, and
the second modular addition operation and the second rotation shift operation are performed on the second block.

16. The method of claim 15, wherein the first block comprises two most significant bits of the result of the initial shuffling operation, and the second block comprises remaining bits, other than the two most significant bits, of the result of the initial shuffling operation.

17. The method of claim 15, wherein
the intermediate shuffling operation comprises a plurality of round shuffling operations, and
each of the plurality of round shuffling operation comprises:
selecting a round key from among the plurality of key sets based on the first block;
performing the second modular addition operation on the round key and on input data received in a previous operation; and
performing the second rotation shift operation on a result of the second modular addition operation in a right direction.

18. The method of claim 14, wherein a shifting direction of the first rotation shift operation is different from a shifting direction of the third rotation shift operation.

19. The method of claim 15, wherein the final shuffling operation comprises:
performing the third modular addition operation on a round key selected based on a result of the intermediate shuffling operation and on the first block of the plurality of key sets;
merging a result of the third modular addition operation and of the first block; and
performing the third rotation shift operation on a result of the merging.

20. The method of claim 17, wherein the shuffling the plurality of rounds is performed a number times based on the number of bit digits and complexity of the numbers of the basic permutation data.
